(19) United States
(12) Patent Application Publication
(10) Pub. No.: US 2007/0011431 A1
(43) Pub. Date: Jan. 11, 2007

(54) ROM software breakpoints

(75) Inventors: Gregory Hogdal, Sammamish, WA (US); James A. Stulz, Bellevue, WA (US); Mark S. Larsen, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/167,727

(22) Filed: Jun. 27, 2005

(51) Int. Cl. G06F 12/00

(52) U.S. Cl. 711/207

(57) ABSTRACT

Software breakpoints for code that normally executes from ROM are set by remapping a page of virtual addresses normally translated to a page of physical addresses in ROM to a page of physical addresses in RAM. This new mapping is stored in the page table and translation look-aside table (TLB). Further, the information stored at the page of ROM is copied to the remapped physical addresses of the RAM. As a result, the ROM information is stored at physical addresses of RAM, and virtual addresses of that ROM code are remapped to these RAM physical addresses. Accordingly, software breakpoints can be written for the ROM code because the code is now stored in RAM.

### BACKGROUND

Tools such as debuggers can be used to find errors in the program code. Some debuggers allow a user to insert one or more breakpoints at selected points in the code, which when executed stops code execution at that point. The user can then inspect various memory/register locations using the debugger to obtain information useful in finding and correcting errors. For example, software breakpoints can be inserted in code being executed from random access memory (RAM) by replacing a selected instruction with a software trap instruction.

Some computing systems have a significant amount of code stored in read only memory (ROM) that is executed from the ROM. Software breakpoints techniques are typically not suitable for ROM code because a selected instruction in ROM cannot easily be replaced with another instruction. To debug such code, hardware debugging techniques are commonly used. Hardware debugging techniques can include on-chip circuitry (typically on the CPU) to compare addresses generated by the CPU and the address at which a breakpoint is desired. Hardware debugging techniques are typically limited in the number of breakpoints that can be implemented due to limitations regarding size/capabilities of the on-chip circuitry.

This background information is not intended to identify problems that must be addressed by the claimed subject matter.

### SUMMARY

This summary is provided to introduce a selection of concepts in a simplified form that are further described below in the Detail Description Section. This summary is not intended to identify key features or essential features of the claimed subject matter, nor is it intended to be used as an aid in determining the scope of the claimed subject matter.

According to various aspects, software breakpoints for code that normally executes from ROM can be set. In one aspect, a remapping component operates to remap a page of virtual addresses normally translated to a page of physical addresses in ROM to a page of physical addresses in RAM; store this new mapping or translation in a page table and translation look-aside table (TLB); and cause the information stored at the page of ROM to be copied to the RAM at the remapped physical addresses. As a result, the ROM information is stored at physical addresses of RAM, and virtual addresses of that ROM code are remapped to these RAM physical addresses. Accordingly, software breakpoints can be written for the ROM code because the code is now stored in RAM.

Various embodiments may be implemented as a computer process, a computing system (including mobile devices) or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a diagram illustrating an exemplary system that supports software breakpoints for ROM code, according to one embodiment.

FIG. 2 is a block diagram illustrating ROM to RAM remapping, according to one embodiment.

FIG. 3 is a flow diagram illustrating operational flow in setting a software breakpoint for code executing from ROM, according to one embodiment.

FIG. 4 is a flow diagram illustrating operational flow in remapping ROM to RAM in a TLB, according to one embodiment.

FIG. 5 is a flow diagram illustrating operational flow in removing a software breakpoint for code executing from ROM, according to one embodiment.

FIG. 6 is a flow diagram illustrating operational flow in remapping from RAM to ROM in a TLB, according to one embodiment.

FIG. 7 is a block diagram illustrating an exemplary computing environment suitable for the embodiments of FIGS. 1-6, according to one embodiment.

### DETAILED DESCRIPTION

Embodiments are described more fully below with reference to the accompanying drawings, which form a part hereof, and which show specific exemplary non-limiting embodiments for practicing the invention. However, embodiments may be implemented in many different forms and should not be construed as limited to the embodiments set forth herein; rather, these embodiments are provided so that this disclosure will be thorough and complete. Embodiments may be practiced as methods, systems or devices. Accordingly, embodiments may take the form of an entirely hardware implementation, an entirely software implementation or an implementation combining software and hardware aspects. The following detailed description is, therefore, not to be taken in a limiting sense.

The logical operations of the various embodiments are implemented (1) as a sequence of computer implemented steps running on a computing system and/or (2) as interconnected machine modules within the computing system. The implementation is a matter of choice dependent on the performance requirements of the computing system implementing the invention. Accordingly, the logical operations making up the embodiments of the present invention described herein are referred to alternatively as operations, steps or modules.

Illustrative System that Supports ROM Software Breakpoints

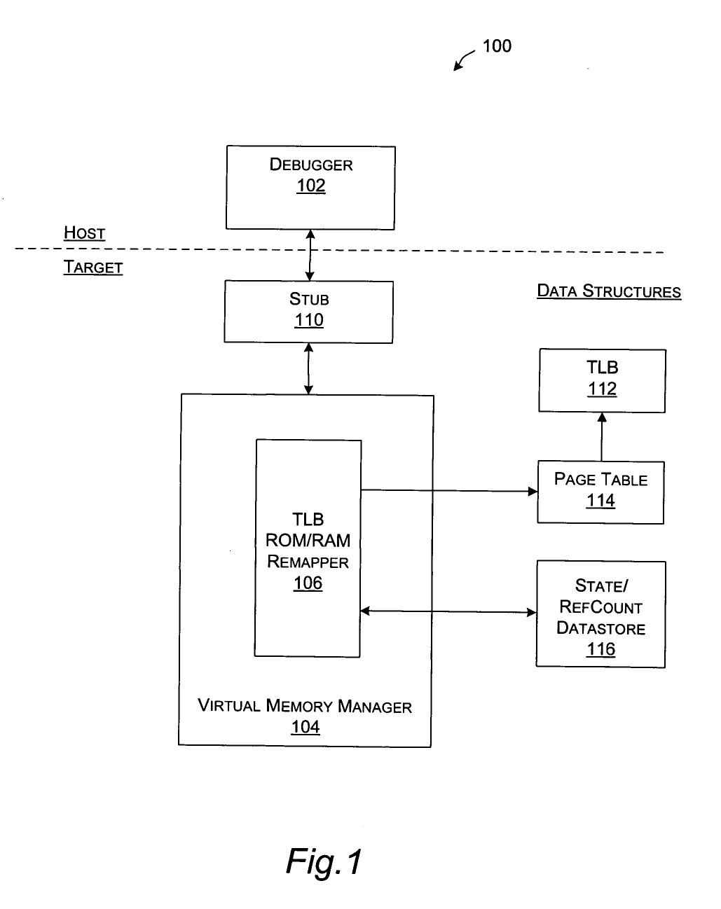

FIG. 1 illustrates an exemplary system 100 that supports software breakpoints for debugging ROM code, according to one embodiment. In this embodiment, system 100 includes a debugger 102, a virtual memory manager 104, which includes a translation look-aside buffer (TLB) ROM/RAM remapper (also referred to herein simply as a remapper) 106. In this embodiment, debugger 102 is part of a host used to debug code that executes on a target. The host may reside in a host computer that is separate from a target computer executing the code to be debugged. Typically, during the debugging process, the target computer executes a stub 110 that allows the target computer to interact with debugger 102.

Virtual memory manager 104 manages a virtual memory system implemented by some operating systems. Virtual memory is used by many operating systems to enlarge the address space that is usable by a program. Virtual memory is typically organized into pages of fixed size (commonly specified by the processor used in the computer). For example, when loaded a program may be allocated a number of pages sufficient to store the entire program. Then when the operating system needs a portion of the program, the operating system copies the page(s) containing that portion into main memory (i.e., RAM). The operating system translates or maps the virtual addresses of the page to physical addresses in RAM. In this embodiment, this translation is stored in a TLB 112 for “recently” used pages. A page table 114 stores all of the page translations and is used to update TLB 106. A state/RefCount datastore (or simply RefCount datastore) 116 is used to store data related to use and release of a page associated with addresses in ROM during operation of debugger 102. For example, RefCount datastore 116 may be used to store a count of the number of breakpoints for each page that has been remapped by remapper 106 and the original translations of virtual addresses to physical addresses before being remapped by remapper 106.

In operation, a user can use debugger 102 to set software breakpoints during code execution by the target computer. The target computer uses a virtual memory system, which is managed by virtual memory manager 104. If the user wishes to set software breakpoints for code that is normally executed from RAM, debugger 102 can implement any suitable software breakpoint technique(s) to set the breakpoint(s).

However, in accordance with this embodiment of system 100, a user can also set software breakpoints for code that normally executes from ROM. In this embodiment, remapper 106 is used to: (a) remap a page of virtual addresses normally translated to a page of physical addresses in ROM to a page of physical addresses in RAM; (b) store this new mapping or translation in page table 114 and TLB 112; and (c) store the original translations in RefCount datastore 116; and (d) cause the code or data stored at the page of ROM to be copied at the remapped physical addresses of RAM. As a result, the ROM code or data is stored at physical addresses of RAM, and virtual addresses of that ROM code are remapped to these RAM physical addresses. Therefore, a user can use debugger 102 to write software breakpoints for the ROM code now stored in RAM.

In some embodiments, when a software breakpoint is written, the instruction being replaced with a trap instruction is stored in RefCount datastore 116. Later, if the user chooses to remove the software breakpoint, the original instruction can be recovered from RefCount datastore 116 and written into the RAM at the physical address of the software trap instruction.

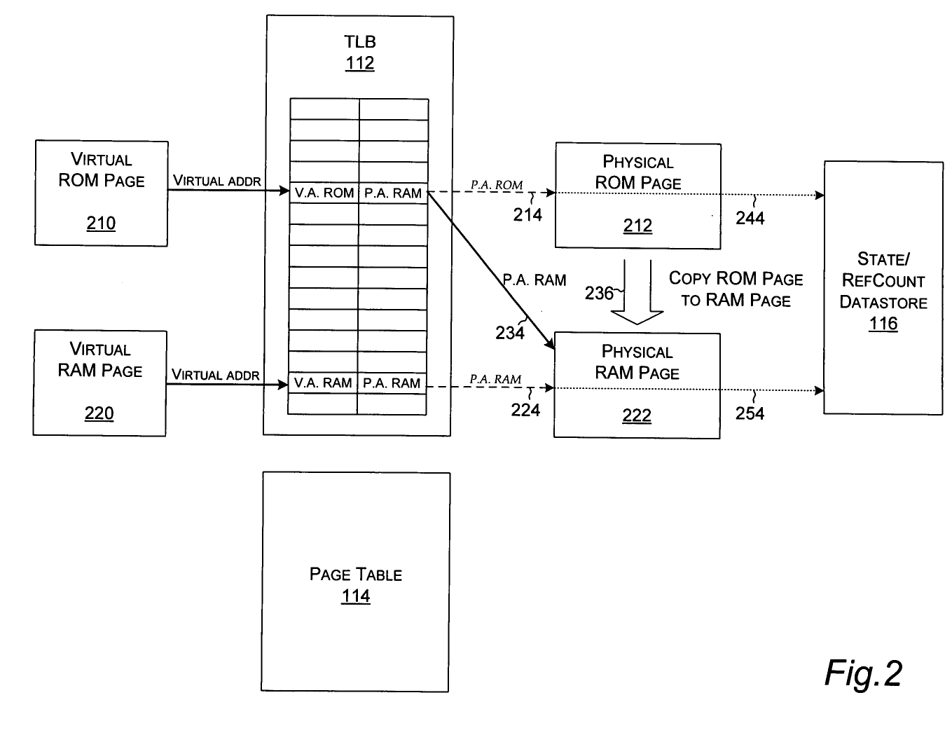

FIG. 2 illustrates ROM-to-RAM remapping in a virtual memory system, according to one embodiment. In this embodiment, ROM-to-RAM remapping is supported by TLB 112, page table 114, and RefCount datastore 116, which are described above in conjunction with FIG. 1. In this example, a virtual ROM page 210 is initially mapped to a physical ROM page 212 of the ROM. Page table 114 and, in this example, TLB 112 would normally store the mapping or translation of virtual ROM page 210 to physical ROM page 212. This “normal” mapping is indicated by a dashed arrow 214.

Similarly, a virtual RAM page 220 is initially mapped to a physical RAM page 222 of the RAM. In some embodiments, physical RAM page 222 is allocated for ROM debugging during an initialization process. Page table 114 and, in this example, TLB 112 would normally store the mapping or translation of virtual RAM page 220 to physical RAM page 222. This “normal” mapping is indicated by a dashed arrow 224.

However, in accordance with the embodiments of the present invention, if there is a need to change information (e.g., data, or code or instructions) stored in physical ROM page 212 (e.g., to set a software breakpoint for debugging purposes), remapper 106 (FIG. 1) can remap page table 114 and TLB 112 so that virtual ROM page 210 is mapped to physical RAM page 222 instead of physical ROM page 212. This “remapping” is indicated by a solid arrow 234 and by the association of the virtual address of the ROM page (shown as V.A. ROM in TLB 112) to the physical address of the physical RAM page (shown as P.A. RAM in TLB 112).

In some embodiments, remapper 106 also causes the information stored in physical ROM page 212 to be copied into physical RAM page 222, as indicated by an arrow 236. In this way, the physical ROM page is now duplicated in RAM, with the virtual addresses of the ROM page “pointing” to the RAM page. As a result, the ROM code of physical ROM page 212 will now be executed from physical RAM page 222; and moreover, a debugger can be used, in effect, to replace an instruction of ROM code with another instruction (e.g., a trap instruction). In some embodiments, remapper 106 also sets a flag or provides some other indication in RefCount datastore 116 that virtual ROM page 210 has been remapped.

In addition, in some embodiments, remapper 106 will cause the original physical ROM page address associated with virtual ROM page 210 to be stored in RefCount datastore 116. This operation is indicated by a dashed arrow 246. Similarly, in these embodiments, remapper 106 can also cause the original physical RAM address associated with virtual RAM page 220 to be stored in RefCount datastore 116. This feature allows remapper 106 to restore the original mapping of virtual ROM and RAM pages 210 and 220 using the original addresses stored in RefCount datastore 116 when there is no longer any need to change information stored in physical ROM page 212. For example, the number of software breakpoints inserted in physical RAM page 222 (after remapping) can be tracked in RefCount datastore 116 using a counter (RefCount) for each page, as previously described. When the RefCount is decremented to zero, remapper 116 may restore the translations of virtual ROM and RAM pages 210 and 220 to their original translations, thereby freeing physical RAM page 222 for other uses.

Illustrative Operational Flow for Setting Software Breakpoints for ROM

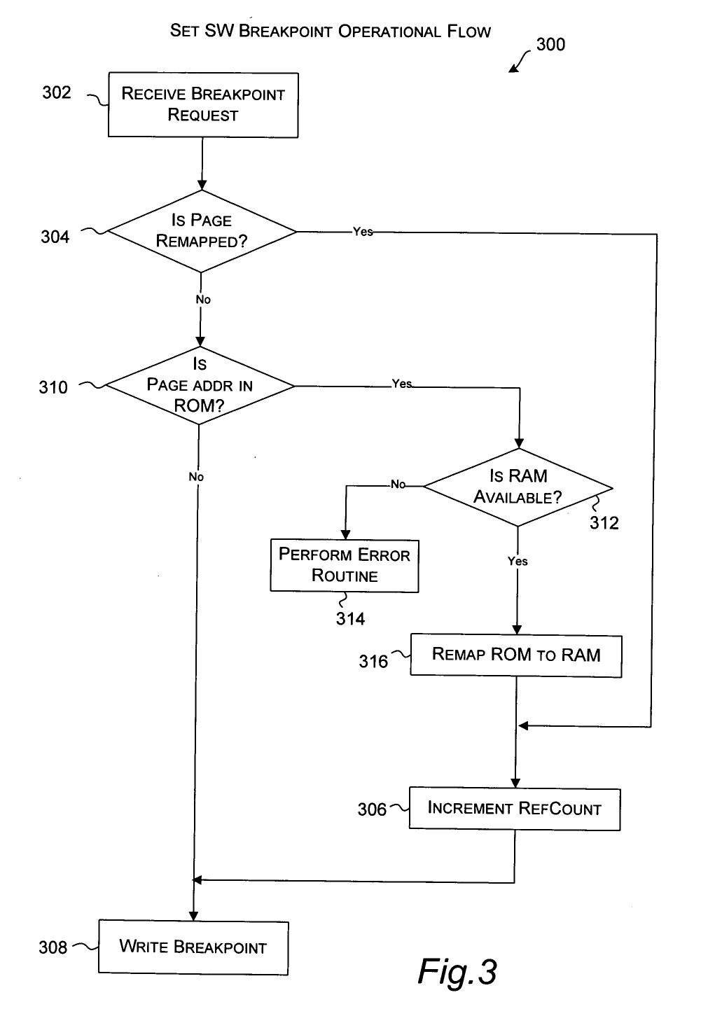

FIG. 3 illustrates an operational flow in setting a software breakpoint for code executing from ROM, according to one embodiment. Operational flow 300 may be performed in any suitable computing environment. For example, operational flow 300 may be executed by a virtual memory system such as system 100 (FIG. 1). Therefore, the description of operational flow 300 may refer to at least one of the components of FIG. 1. However, any such reference to components of FIG. 1 is for descriptive purposes only, and it is to be understood that the implementations of FIG. 1 are a non-limiting environment for operational flow 300.

At a block 302, a request for a software breakpoint is received. In one embodiment, the request is generated by a debugger such as debugger 102 (FIG. 1) and is received by a target that uses a virtual memory system. In this example, the software breakpoint request includes a virtual address of an instruction that is to be replaced with a trap instruction. Operational flow 300 can proceed to a block 304.

At block 304, it is determined whether the virtual address of the software breakpoint request is contained in a page that has been remapped. That is, it is determined whether the page is still mapped to the original physical address defined during initialization of the target system. In one embodiment, a remapping component such as remapper 106 (FIG. 1) determines whether the virtual address is contained in a page that has been remapped. In some embodiments, the remapping component can inspect a flag or other indicator that is set in response to a remapping of a virtual page from the original mappings. One embodiment of this remapping operation is described below in conjunction with block 316. If the page has not been remapped, operational flow 300 can proceed to a block 310, which is described further below. However, if the page has been remapped, operational flow 300 can proceed to a block 306.

At block 306, a counter such as the aforementioned RefCount counter is incremented to indicate that the page has another software breakpoint. In this embodiment, the counter is used to track the number of software breakpoints inserted into a page and is maintained in a datastore such as RefCount datastore 116 (FIG. 1). Each page in the “remapped” state will have a similar counter. This counter can be used to determine when the page is no longer needs to be remapped. For example, if the counter is decremented to zero as the debugger is used to remove software breakpoints (which can indicate that the page is no longer needed for software breakpoints), then the virtual addresses of the page can be remapped to the original physical addresses, thereby freeing the physical RAM page for other uses. Operational flow 300 can proceed to a block 308.

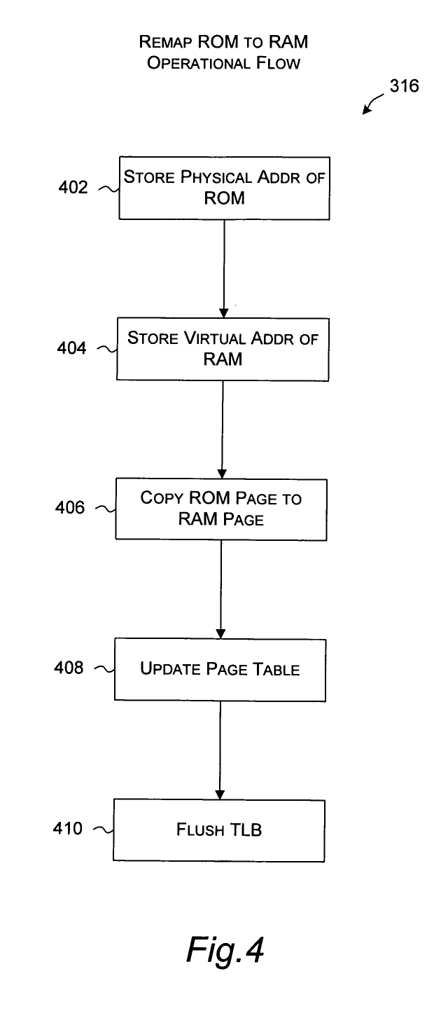

At block 308, the software breakpoint is written to the physical address of the RAM (i.e., after the remapping) that corresponds to the virtual address included in the request. In one embodiment, the aforementioned remapping component copies the original instruction (at the corresponding physical address of the RAM) into the datastore and then writes a software trap instruction at the same location. Operational flow 300 then ends, allowing the system to respond to another software breakpoint request or perform other processes such as those described in conjunction with FIGS. 4-6. Returning to block 304, if it is determined that the page was not remapped, operational flow 300 can proceed to block 310.

At block 310, it is determined whether the physical address of the page corresponding to virtual address of the software breakpoint request is in ROM. In one embodiment, the aforementioned remapping component inspects the virtual address included in the request, and the corresponding physical address in the TLB (such as TLB 112 of FIG. 1). From the corresponding physical address, the remapping component can determine if the physical address is a ROM address. If the page is not in ROM (i.e., it is in RAM), operational flow 300 can proceed to previously described block 308 so that the software breakpoint can be written into RAM, which is the normal operational flow for writing software breakpoints. However, if the page is in ROM, operational flow 300 can proceed to a block 312.

At block 312, it is determined whether a RAM page is available. In one embodiment, the aforementioned remapping component determines whether a RAM page is available for use. For example, during an initialization process, the debugger can cause the target system to allocate a preselected number of RAM pages for use by the remapping component. If it is determined that there is a RAM page available, operational flow 300 can proceed to a block 316, described further below. However, if it is determined that there is no RAM page available, operational flow 300 can proceed to a block 314.

At block 314, an error routine is performed. In one embodiment, the aforementioned remapping component performs the error routine. For example, one error routine causes the target system to display an error message to the user of the debugger. The error message may provide a user interface for the user to cancel the software breakpoint request, delete software breakpoint(s) on another page, allocate more RAM, etc. At this point, operational flow 300 terminates, and the target system is free to receive a new breakpoint request (for example, if the user decides to delete breakpoint(s) on another page, by allocating more memory, or by requesting a software breakpoint on a page that has already been remapped) by returning to block 302.

At block 316, the virtual address of the ROM page containing the address of the software breakpoint request is remapped to an available physical RAM page. In one embodiment, the aforementioned remapping component causes the information of the ROM page to be copied to the RAM page and change the virtual ROM address mapping in the page table (and in the TLB) to the physical RAM page that contains the copied ROM information. In some embodiments, additional operations may be performed, as described below in conjunction with FIG. 4. Operational flow 300 can then proceed to previously described blocks 306 and 308 to increment the count of software breakpoints in the remapped RAM page and to write the requested software breakpoint.

Although operational flow 300 is illustrated and described sequentially in a particular order, in other embodiments, the operations described in the blocks may be performed in different orders, multiple times, and/or in parallel. Further, one or more operations described in the blocks may be omitted or combined in some embodiments.

Illustrative Operational Flow for Remapping V.A. ROM to P.A. RAM

FIG. 4 is a flow diagram illustrating operational flow in remapping ROM to RAM in a virtual memory system, according to one embodiment. For example, operational flow 400 may be used to implement an embodiment of block 316 (FIG. 3). Operational flow 400 may be performed in any suitable computing environment. For example, operational flow 400 may be executed by a virtual memory system such as system 100 (FIG. 1). Therefore, the description of operational flow 400 may refer to at least one of the components of FIG. 1. However, any such reference to components of FIG. 1 is for descriptive purposes only, and it is to be understood that the implementations of FIG. 1 are a non-limiting environment for operational flow 400.

At a block 402, a physical address of a ROM page is stored. In one embodiment, a remapping component such as remapper 106 (FIG. 1), responsive to a request for a software breakpoint in ROM code, can inspect a TLB (or a page table) to obtain the physical address of the ROM page (which contains the physical address associated with the software breakpoint request). The remapping component can then store the physical address of the ROM page in a datastore such as RefCount datastore 116 (FIG. 1). Thus, the physical address of the ROM page is available for later use in restoring the page table to the original translation, if desired. Operational flow 400 can then proceed to a block 404.

At block 404, the virtual address of a RAM page (i.e., the RAM page to which the ROM page is to be copied) is stored. In one embodiment, the aforementioned remapping component stores the virtual address in the same datastore as the physical address of the ROM page (block 402). Thus, the virtual address of the RAM page is available for later use in releasing it to the poll of RAM available for remapping, if desired. Operational flow 400 can then proceed to a block 406.

At block 406, the information stored in the physical ROM page is copied into the RAM page. In one embodiment, the aforementioned remapping component causes the information (e.g., code or instructions) stored in the ROM page to be copied into the RAM page (see block 404). For example, this RAM page can be one that was allocated for debugging during an initialization process. Operational flow 400 can then proceed to a block 408.

At block 408, the page table of the virtual memory system is updated. In one embodiment, the aforementioned remapping component causes the page table to reflect the remapping of the virtual address (which was originally translated to the physical ROM page) to the physical RAM page. Operational flow 400 can then proceed to a block 410.

At block 410, the TLB is flushed or updated. In one embodiment, the aforementioned mapping component causes the TLB to be updated using the page table updated at block 408. In this way, the TLB is updated so that the virtual address that was originally translated to a physical ROM page is now translated to a physical RAM page in which the ROM page information (e.g., instructions) was copied.

Although operational flow 400 is illustrated and described sequentially in a particular order, in other embodiments, the operations described in the blocks may be performed in different orders, multiple times, and/or in parallel. Further, one or more operations described in the blocks may be omitted or combined in some embodiments.

Illustrative Operational Flow for Removing Software Breakpoints for ROM

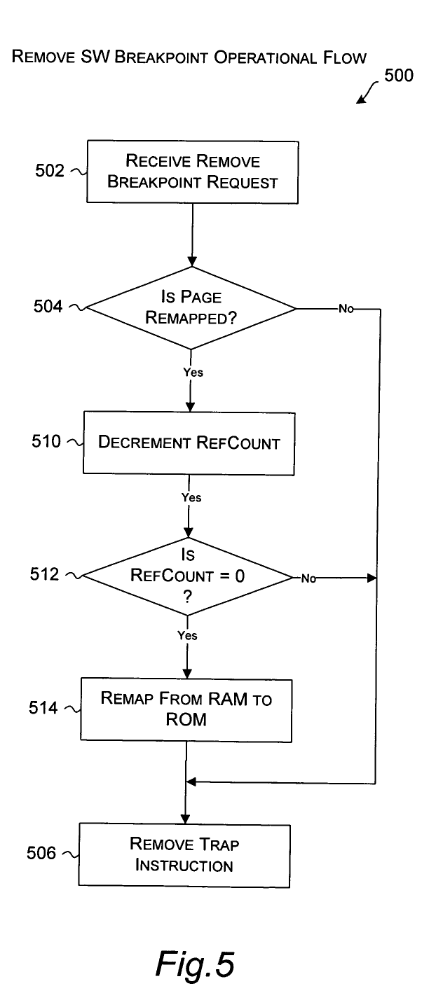

FIG. 5 is a flow diagram illustrating operational flow in removing a software breakpoint for code executing from ROM, according to one embodiment. Operational flow 500 may be performed in any suitable computing environment. For example, operational flow 500 may be executed by a virtual memory system such as system 100 (FIG. 1). Therefore, the description of operational flow 500 may refer to at least one of the components of FIG. 1. However, any such reference to components of FIG. 1 is for descriptive purposes only, and it is to be understood that the implementations of FIG. 1 are a non-limiting environment for operational flow 500.

At a block 502, a request to remove a software breakpoint is received. In one embodiment, the request is generated by a user via a debugger such as debugger 102 (FIG. 1) and is received by a target that uses a virtual memory system. In this example, the request to remove the software breakpoint includes a virtual address of a trap instruction to be removed. Operational flow 500 can proceed to a block 504.

At block 504, it is determined whether the page containing the software breakpoint has been remapped. That is, it is determined whether or not the page is still mapped to the original physical address defined during initialization of the target system. In one embodiment, a remapping component such as remapper 106 (FIG. 1) determines whether the virtual address is contained in a page that has been remapped. In some embodiments, the remapping component can inspect a flag or other indicator that is set in response to a remapping of a virtual page from the original mappings. If the page has been remapped, operational flow 500 can proceed to a block 510, which is described further below. However, if the page has not been remapped (i.e., the software breakpoint is for RAM code rather than ROM code), operational flow 500 can proceed to a block 506.

At block 506, the software breakpoint is removed. In one embodiment, the aforementioned remapping component causes the RAM location which contains the trap instruction to be written with the original instruction, as in a standard software breakpoint system. Operational flow 500 then ends, allowing the system to respond to another software breakpoint request or perform other processes such as those described in conjunction with FIGS. 3-5 and 6. Returning to block 504, if it is determined that the page was remapped, operational flow 500 can proceed to block 510.

At block 510, a counter such as the aforementioned RefCount counter is decremented to indicate that the page has had a software breakpoint removed. In this embodiment, the counter is used to track the number of software breakpoints inserted into a page and is maintained in a datastore such as RefCount datastore 116 (FIG. 1). Each page in the “remapped” state will have a similar counter. In one embodiment, the aforementioned remapping component decrements the counter. Operational flow 500 can then proceed to a block 512.

At block 512, it is determined whether the counter has a value equal to zero. In one embodiment, the aforementioned remapping component determines whether the counter value is equal to zero. If the counter value is not equal to zero (i.e., there are still software breakpoints on the page), operational flow 500 can proceed to previously-described block 506 in which the software breakpoint is removed. However, if the counter value is equal to zero (i.e., there are no more software breakpoints on the page), operational flow 500 can proceed to a block 514.

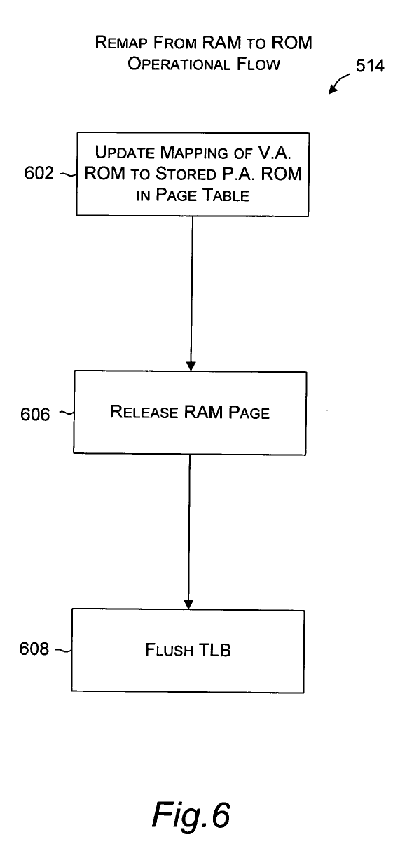

At block 514, the virtual address that had been remapped to the physical RAM page that once contained a software breakpoint(s) is remapped again so that the virtual address is translated back to the original physical ROM page. This remapping back to the original ROM page can free the RAM page for other uses. In one embodiment, the aforementioned remapping component causes the virtual address to be translated back to the original physical ROM page address in the page table (and the TLB). In some embodiments, additional operations may be performed, as described below in conjunction with FIG. 6. Operational flow 500 can then proceed to previously described block 506 to remove the software breakpoint.

Although operational flow 500 is illustrated and described sequentially in a particular order, in other embodiments, the operations described in the blocks may be performed in different orders, multiple times, and/or in parallel. Further, one or more operations described in the blocks may be omitted or combined in some embodiments.

Illustrative Operational Flow for Remapping V.A. ROM Back to P.A. ROM

FIG. 6 is a flow diagram illustrating operational flow in remapping RAM to ROM in a TLB, according to one embodiment. For example, operational flow 600 may be used to implement an embodiment of block 514 (FIG. 5). Operational flow 600 may be performed in any suitable computing environment. For example, operational flow 600 may be executed by a virtual memory system such as system 100 (FIG. 1). Therefore, the description of operational flow 600 may refer to at least one of the components of FIG. 1. However, any such reference to components of FIG. 1 is for descriptive purposes only, and it is to be understood that the implementations of FIG. 1 are a non-limiting environment for operational flow 600.

At a block 602, the page table of a virtual memory system is updated to return the translation of a virtual RAM address to its original physical ROM page translation. For example, in setting the software breakpoint for an instruction stored in ROM, a virtual address for the physical ROM page containing the instruction can be remapped to a physical RAM page into which the ROM page information has been copied (e.g., block 316 of FIG. 3). At block 602, this translation is reversed so that the virtual address is again translated to the physical ROM page. In one embodiment, a remapping component such as remapper 106 (FIG. 1) remaps the page table so that virtual address is mapped to the original physical ROM page. The remapping component, in this embodiment, retrieves the original ROM page physical address from a datastore such as RefCount datastore 116 (FIG. 1). In this embodiment, the remapping component had stored the original ROM page physical address as part of the process of setting the ROM software breakpoint (e.g., see block 402 of FIG. 4). Operational flow 600 can proceed to a block 606.

At block 606, the RAM page is released to the poll of available RAM available for remapping. Thus, the RAM page is available for storing another page of ROM information for a different ROM software breakpoint request. Operational flow 600 can proceed to a block 608.

At block 608, the TLB is flushed or updated. In one embodiment, the aforementioned mapping component causes the TLB to be updated using the page table updated at blocks 602 and 604. In this way, the TLB is updated so that the virtual address that was originally translated to a physical ROM page before the ROM software breakpoint was written is now translated back to the physical ROM page.

Although operational flow 600 is illustrated and described sequentially in a particular order, in other embodiments, the operations described in the blocks may be performed in different orders, multiple times, and/or in parallel. Further, one or more operations described in the blocks may be omitted or combined in some embodiments.

Illustrative Operating Environment

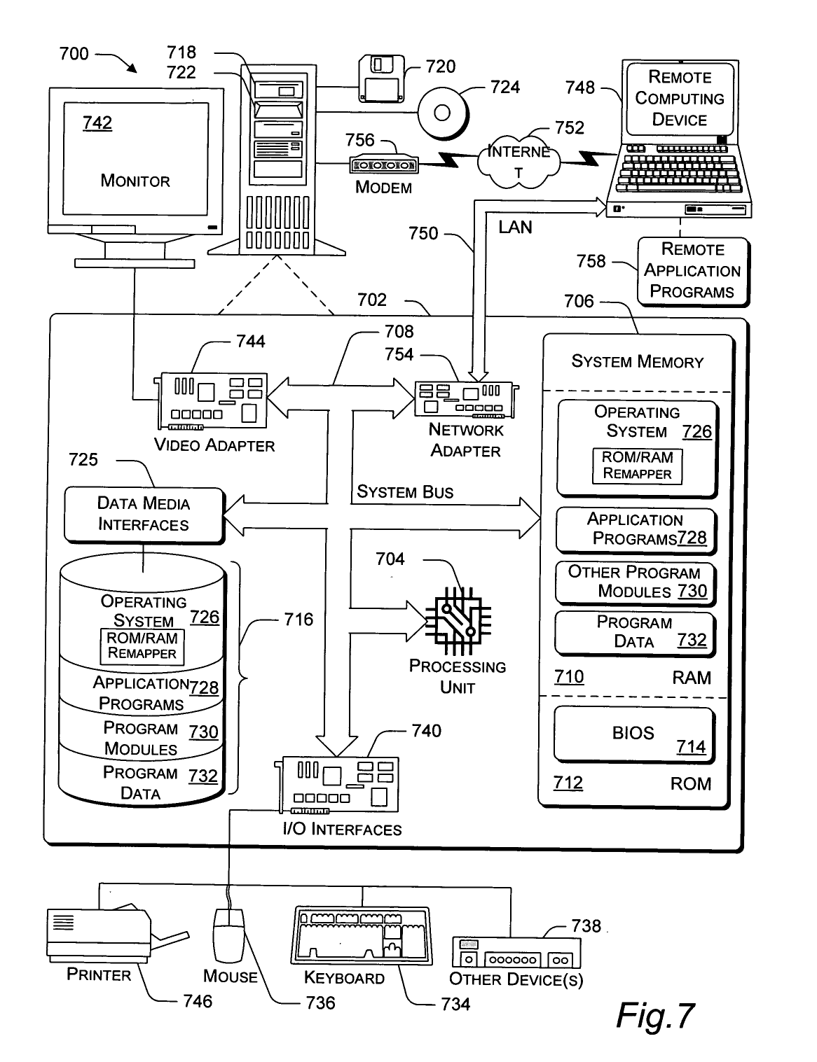

FIG. 7 illustrates a general computer environment 700, which can be used to implement the techniques described herein. The computer environment 700 is only one example of a computing environment and is not intended to suggest any limitation as to the scope of use or functionality of the computer and network architectures. Neither should the computer environment 700 be interpreted as having any dependency or requirement relating to any one or combination of components illustrated in the example computer environment 700.

Computer environment 700 includes a general-purpose computing device in the form of a computer 702. The components of computer 702 can include, but are not limited to, one or more processors or processing units 704, system memory 706, and system bus 708 that couples various system components including processor 704 to system memory 706.

System bus 708 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, a Peripheral Component Interconnects (PCI) bus also known as a Mezzanine bus, a PCI Express bus, a Universal Serial Bus (USB), a Secure Digital (SD) bus, or an IEEE 1394, i.e., FireWire, bus.

Computer 702 may include a variety of computer readable media. Such media can be any available media that is accessible by computer 702 and includes both volatile and non-volatile media, removable and non-removable media.

System memory 706 includes computer readable media in the form of volatile memory, such as random access memory (RAM) 710; and/or non-volatile memory, such as read only memory (ROM) 712 or flash RAM. Basic input/output system (BIOS) 714, containing the basic routines that help to transfer information between elements within computer 702, such as during start-up, is stored in ROM 712 or flash RAM. RAM 710 typically contains data and/or program modules that are immediately accessible to and/or presently operated on by processing unit 704.

Computer 702 may also include other removable/non-removable, volatile/non-volatile computer storage media. By way of example, FIG. 7 illustrates hard disk drive 716 for reading from and writing to a non-removable, non-volatile magnetic media (not shown), magnetic disk drive 718 for reading from and writing to removable, non-volatile magnetic disk 720 (e.g., a “floppy disk”), and optical disk drive 722 for reading from and/or writing to a removable, non-volatile optical disk 724 such as a CD-ROM, DVD-ROM, or other optical media. Hard disk drive 716, magnetic disk drive 718, and optical disk drive 722 are each connected to system bus 708 by one or more data media interfaces 725. Alternatively, hard disk drive 716, magnetic disk drive 718, and optical disk drive 722 can be connected to the system bus 708 by one or more interfaces (not shown).

The disk drives and their associated computer-readable media provide non-volatile storage of computer readable instructions, data structures, program modules, and other data for computer 702. Although the example illustrates a hard disk 716, removable magnetic disk 720, and removable optical disk 724, it is appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the example computing system and environment.

Any number of program modules can be stored on hard disk 716, magnetic disk 720, optical disk 724, ROM 712, and/or RAM 710, including by way of example, operating system 726 (which can include embodiments of the ROM/RAM remapper described above), one or more application programs 728, other program modules 730, and program data 732. Each of such operating system 726, one or more application programs 728, other program modules 730, and program data 732 (or some combination thereof) may implement all or part of the resident components that support the distributed file system.

A user can enter commands and information into computer 702 via input devices such as keyboard 734 and a pointing device 736 (e.g., a “mouse”). Other input devices 738 (not shown specifically) may include a microphone, joystick, game pad, satellite dish, serial port, scanner, and/or the like. These and other input devices are connected to processing unit 704 via input/output interfaces 740 that are coupled to system bus 708, but may be connected by other interface and bus structures, such as a parallel port, game port, or a universal serial bus (USB).

Monitor 742 or other type of display device can also be connected to the system bus 708 via an interface, such as video adapter 744. In addition to monitor 742, other output peripheral devices can include components such as speakers (not shown) and printer 746 which can be connected to computer 702 via I/O interfaces 740.

Computer 702 can operate in a networked environment using logical connections to one or more remote computers, such as remote computing device 748. By way of example, remote computing device 748 can be a PC, portable computer, a server, a router, a network computer, a peer device or other common network node, and the like. Remote computing device 748 is illustrated as a portable computer that can include many or all of the elements and features described herein relative to computer 702. Alternatively, computer 702 can operate in a non-networked environment as well.

Logical connections between computer 702 and remote computer 748 are depicted as a local area network (LAN) 750 and a general wide area network (WAN) 752. Such networking environments are commonplace in offices, enterprise-wide computer networks, intranets, and the Internet.

When implemented in a LAN networking environment, computer 702 is connected to local network 750 via network interface or adapter 754. When implemented in a WAN networking environment, computer 702 typically includes modem 756 or other means for establishing communications over wide network 752. Modem 756, which can be internal or external to computer 702, can be connected to system bus 708 via I/O interfaces 740 or other appropriate mechanisms. It is to be appreciated that the illustrated network connections are examples and that other means of establishing at least one communication link between computers 702 and 748 can be employed.

In a networked environment, such as that illustrated with computing environment 700, program modules depicted relative to computer 702, or portions thereof, may be stored in a remote memory storage device. By way of example, remote application programs 758 reside on a memory device of remote computer 748. For purposes of illustration, applications or programs and other executable program components such as the operating system are illustrated herein as discrete blocks, although it is recognized that such programs and components reside at various times in different storage components of computing device 702, and are executed by at least one data processor of the computer.

Various modules and techniques may be described herein in the general context of computer-executable instructions, such as program modules, executed by one or more computers or other devices. Generally, program modules include routines, programs, objects, components, data structures, etc. for performing particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. As a non-limiting example only, communication media includes wired media such as a wired network or direct-wired connection, and wireless media such as acoustic, RF, infrared, and other wireless media. Combinations of any of the above are also included within the scope of computer readable media.

Reference has been made throughout this specification to “one embodiment,” “an embodiment,” or “an example embodiment” meaning that a particular described feature, structure, or characteristic is included in at least one embodiment of the present invention. Thus, usage of such phrases may refer to more than just one embodiment. Furthermore, the described features, structures, or characteristics may be combined in any suitable manner in one or more embodiments.

One skilled in the relevant art may recognize, however, that the invention may be practiced without one or more of the specific details, or with other methods, resources, materials, etc. In other instances, well known structures, resources, or operations have not been shown or described in detail merely to avoid obscuring aspects of the invention.

While example embodiments and applications of the present invention have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the claimed invention.

What is claimed is:

1. A method for setting a software breakpoint in a virtual memory system, the method comprising:
determining whether a request for adding a software breakpoint is at a physical address located in a read only memory (ROM) address space;
copying information stored in a ROM page to a random access memory (RAM) page in response to the physical address being located in the ROM address space, wherein the physical address is contained in the ROM page's address range; and
configuring a page table of the virtual memory system so that a virtual address translated to the ROM page before the copying is translated to the RAM page.

2. The method of claim 1 further comprising determining whether the physical address is location in a ROM page that has had its stored information copied to a RAM page.

3. The method of claim 1 further comprising determining whether a RAM page is available before copying information stored in the ROM page.

4. The method of claim 1 further comprising writing a software breakpoint in the RAM page in response to the request.

5. The method of claim 1 further comprising incrementing a count of software breakpoints in the RAM page.

6. The method of claim 1 further comprising storing a physical address of the ROM page in a datastore.

7. The method of claim 1 further comprising updating a translation look-aside buffer (TLB) after configuring the page table.

8. The method of claim 1 further comprising storing a virtual address of the RAM page that was mapped before the copying.

9. One or more computer-readable media having stored thereon instructions that when executed perform operations implementing the method of claim 1.

10. A method for removing a software breakpoint in a virtual memory system, the method comprising:
determining whether a request for removing a software breakpoint is at a physical address located in a read only memory (ROM) page's address range, wherein information stored in the ROM page has been copied to a random access memory (RAM) page;
in response to a determination that the information stored in the ROM page has been copied to a RAM page, determining whether the RAM page will contain at least one software breakpoint after removing the software breakpoint of the request; and
removing the software breakpoint of the request.

11. The method of claim 10 wherein determining whether the RAM page will contain at least one software breakpoint further comprises decrementing a count of software breakpoints contained in the RAM page.

12. The method of claim 10 further comprising, in response to a determination that the RAM page will not contain at least one software breakpoint after removing the software breakpoint of the request, configuring a page table so that a virtual address that was translated to the RAM page before the removing is translated to the ROM page.

13. The method of claim 12 further releasing the RAM page for another possible use after the configuring the page table.

14. The method of claim 12 further comprising updating a translation look-aside buffer (TLB) after configuring the page table.

15. One or more computer-readable media having stored thereon instructions that when executed perform operations implementing the method of claim 10.

16. A system for supporting software breakpoints for instructions stored in read only memory (ROM), the system comprising:
a virtual memory manager; and
a remapping component to remap a ROM page to a random access memory (RAM) page, wherein remapping a ROM page comprises, in response to a request to add a software breakpoint to the ROM page:
copying information stored in the ROM page to the RAM page,
updating a page table so that a virtual address that was translated to the ROM page before the copying to be translated to the RAM page, and
writing the software breakpoint of the request to the RAM page.

17. The system of claim 16 updating a translation look-aside buffer (TLB) after the page table is updated.

18. The system of claim 16 wherein the remapping further comprises storing a physical address of the ROM page in a datastore.

19. The system of claim 19 wherein the remapping component is also to remap the RAM page when a remapped ROM page has had all software breakpoints removed from the RAM page, wherein remapping the RAM page comprises.
causing the virtual address that was translated to the RAM page after the copying is translated back to the ROM page, and
releasing the RAM page for another possible use.

20. One or more computer-readable media having stored thereon instructions that when executed perform operations implementing the system of claim 16.
